(19) United States
(12) Patent Application Publication
(10) Pub. No.: US 2014/0025703 A1
(43) Pub. Date: Jan. 23, 2014

(54) INTELLIGENT DATA EXPLORATION AND ANALYTICS SYSTEM

(71) Applicant: The SI Organization, Inc., King of Prussia, PA (US)

(72) Inventors: Charles Samuels, Chester Springs, PA (US); Earl Jordan Dodd, Cypress, TX (US)

(73) Assignee: The SI Organization, Inc., King of Prussia, PA (US)

(21) Appl. No.: 13/948,739

(22) Filed: Jul. 23, 2013

Related U.S. Application Data
(60) Provisional application No. 61/674,437, filed on Jul. 23, 2012.

(51) Int. Cl. G06F 17/30

(52) U.S. Cl. CPC G06F 17/30424
USPC 707/769

(57) ABSTRACT

Systems and methods for providing an intelligent response are disclosed. The systems and methods may include a processing device that performs the following: receiving a request from a user, translating the request into one or more intelligent query parameters, querying a plurality of sources in accordance with the one or more intelligent query parameters, obtaining data from the plurality of sources, generating a response to the request from the natural language data and providing the response to the user. The response may contain a report that has at least a portion of the data from at least two sources.

### CROSS-REFERENCE TO RELATED APPLICATIONS

This application claims priority to U.S. Provisional Application Ser. No. 61/674,437, filed Jul. 23, 2012 and entitled, “INTELLIGENT DATA EXPLORATION AND ANALYTICS SYSTEM”, which is incorporated herein by reference in its entirety.

### BACKGROUND

Recently, data volumes, datasets and scientific models related to the earth imagery, mapping and the like have expanded and proliferated at a rapid pace due to the increasing amount of data that has been obtained by researchers, scientists, analysts, professionals and the like, as well as easily available and cost effective storage devices for storing the data. As a result, users seeking to access information from those data volumes face increasing difficulty in finding an exact answer to suit their needs.

Currently, only experienced scientists and persons technically proficient in data acquisition and analysis with extensive knowledge of search terms and queries may be able to access the data without undue difficulty. However, less experienced scientists, applied scientists and other professionals without this knowledge or access to references may encounter challenges and/or difficulty in their attempts to discover and access data.

### SUMMARY

In an embodiment, a method of providing an intelligent response may include the following: receiving, by a processing device, a request from a user, translating, by the processing device, the request into one or more intelligent query parameters, querying, by the processing device, a plurality of sources in accordance with the one or more intelligent query parameters, obtaining, by the processing device, data from the plurality of sources, generating, by the processing device, a response to the request from the data and providing, by the processing device, the response to the user. The response may include a report containing at least a portion of the data from at least two sources.

In an embodiment, a system for providing an intelligent response may include a processing device and a non-transitory, processor-readable storage medium in communication with the processing device. The non-transitory, processor-readable storage medium may have one or more programming instructions that, when executed, cause the processing device to receive a request from a user, translate the request into one or more intelligent query parameters, query a plurality of sources in accordance with the one or more intelligent query parameters, obtain data from the plurality of sources, generate a response to the request from the data and provide the response to the user. The response may include a report containing at least a portion of the data from at least two sources.

### BRIEF DESCRIPTION OF THE DRAWINGS

FIG. 1A depicts a general schematic representation of an operating environment arranged in accordance with at least some embodiments described herein.

FIG. 1B depicts a general schematic representation of an operating environment arranged in accordance with other embodiments described herein.

FIG. 2 depicts a block diagram of illustrative internal hardware that may be used to contain or implement programming instructions according to an embodiment.

FIG. 3 depicts a flow diagram of a process for querying and providing an intelligent response to a request according to an embodiment.

FIGS. 4A-4C depict an illustrative report that is generated in response to a query according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processing device and a tangible, computer-readable memory or storage device. The memory may contain programming instructions that, when executed by the processing device, cause the device to perform one or more operations according to the programming instructions. Examples of electronic devices include personal computers, supercomputers, gaming systems, televisions and mobile devices.

A “mobile device” refers to an electronic device that is generally portable in size and nature. Accordingly, a user may transport a mobile device with relative ease. Examples of mobile devices include pagers, cellular phones, feature phones, smartphones, personal digital assistants (PDAs), cameras, tablet computers, phone-tablet hybrid devices, laptop computers, netbooks, ultrabooks, global positioning satellite (GPS) navigation devices, in-dash automotive components, media players, watches and the like.

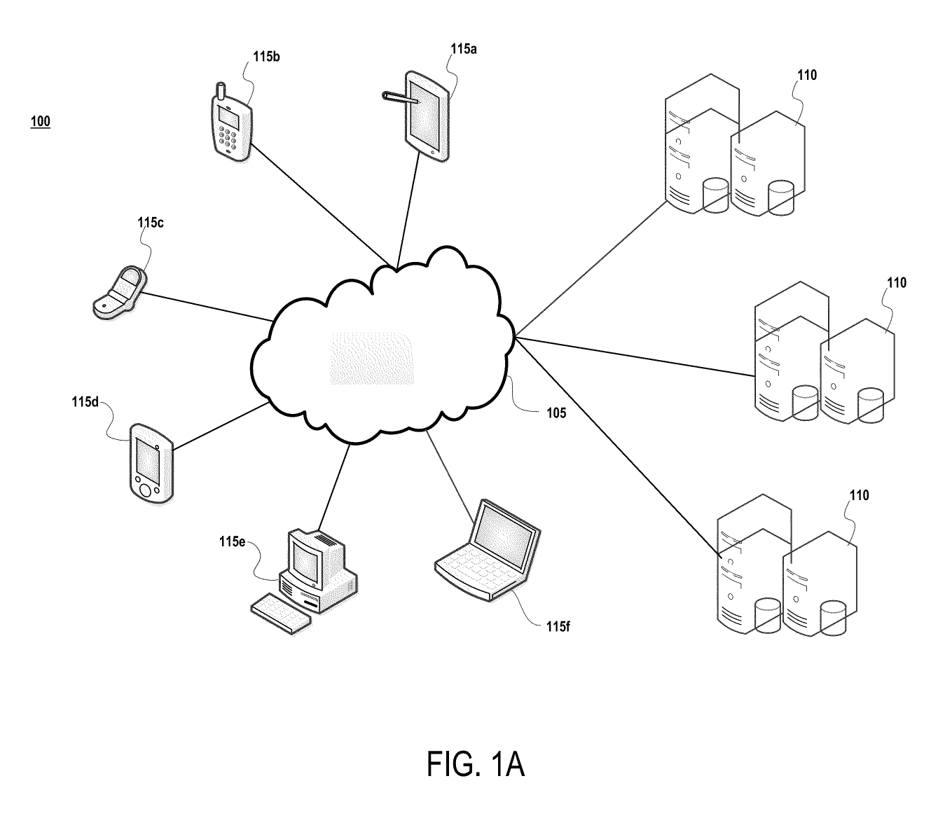

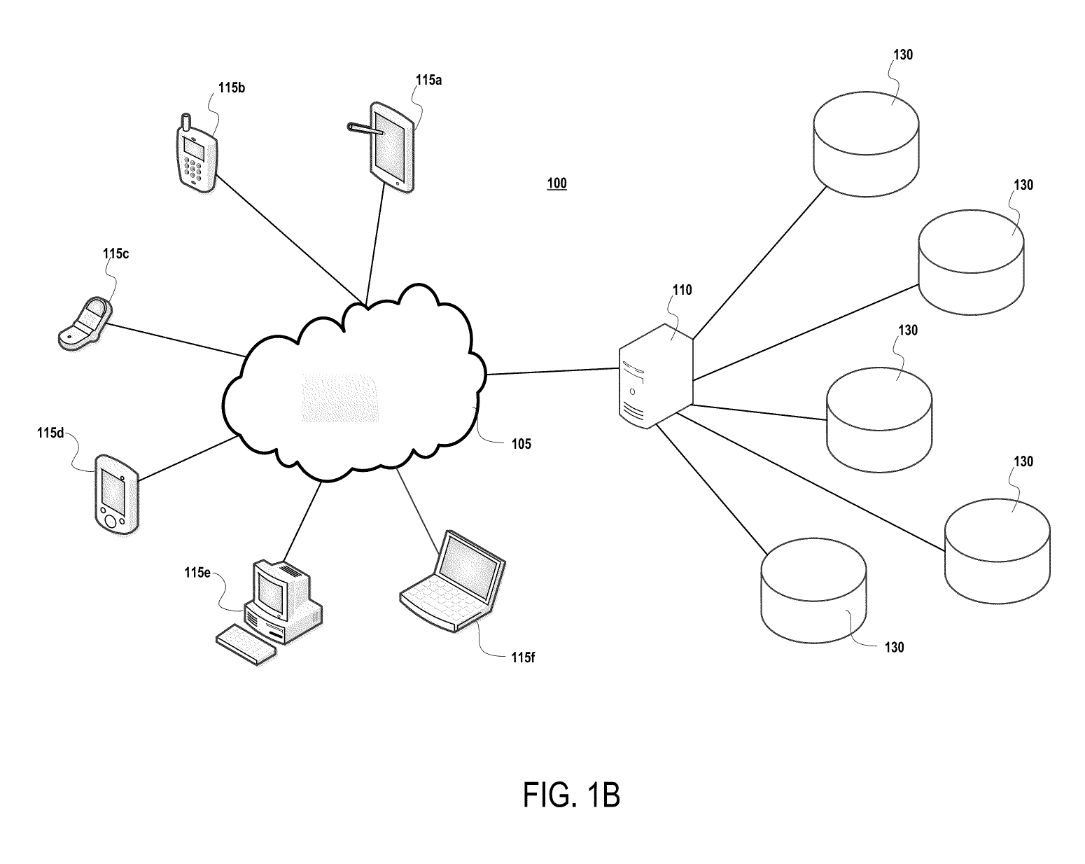

A “computing device” is an electronic device, such as, for example, a computer, a server, a plurality of servers or components thereof. A computing device can be maintained by entities such as financial institutions, educational and research institutions, corporations, governments, tribal organizations, and/or the like. A computing device may generally contain a memory or other storage device for housing programming instructions, data, information and/or the like. The data may optionally be contained in a database, metabase, knowledge base and/or the like, which is stored in the memory or another storage device, which may optionally be external to the computing device. The data may optionally be secured by any method now known or later developed for securing data. A computing device may further be in operable communication with one or more electronic devices as depicted, for example, in FIGS. 1A and 1B. Communication between a computing device and a mobile device may further be secured by any method now known or later developed for securing transmissions or other forms of communication. A computing device may further contain a registry of “authorized users” wherein the authorized users are users that have registered to use the systems and methods described herein. Users may obtain “authorized user” status by, for example, providing contact information, account information, passcodes, usage preferences, collaboration preferences and/or the like.

A “source” refers to one or more information repositories that are searchable by any of the components described herein. Information repositories are not limited by this disclosure, and may include any number of knowledge bases, databases, data sets, data volumes, scientific models, metabases, libraries, logs, flat files and/or the like. The information repositories may generally be related to the fields of geospatial information, climatology, plant and animal morbidity and mortality, insurance and actuarial science, emergency and disaster management, forestry and fire service management, mapping, mineral exploration and extraction, natural resource exploration and extraction, petroleum exploration and extraction, hydrology, water management, geology, food security, and academic research. The sources may be located, for example, on a computing device or a component thereof, such as the computing devices described herein. Each source may contain information that may or may not relate to a query presented by a user, as described herein. Examples of sources may include, for example, a United States government agency database, a metabase, a satellite database, an aerial image database, an imagery database, a health database, an actuary database, a user derived content database, a knowledge base and/or the like.

A “knowledge base” refers to a repository of indexable and searchable data. A knowledge base may include a software component, such as, but not limited to, a database, a flat file and/or a table. Alternatively, a knowledge base may include a hardware component, such as, but not limited to, a tangible storage medium. As discussed below, a “semantic knowledge base” is a specific embodiment of a knowledge base. A semantic knowledge base includes data in the form of an ontology with one or more taxonomies and/or association references.

A “semantic reasoner” refers to a system including one or more computing devices in operable communication with a semantic knowledge base.

The present disclosure pertains to methods and systems for presenting an intelligent query interface to a user in a centralized location, providing intelligent querying functions and compiling intelligent responses to users' requests based upon results obtained by the intelligent querying functions. The intelligent responses can be provided more quickly than if a user had to search for answers on his or her own. Furthermore, the intelligent responses can be provided in simple terms that make it easier for a user to understand data obtained from the results without having to spend an inordinate amount of time trying to understand the results and decipher what the results mean.

Referring to FIG. 1A, a general schematic representation of an operating environment 100 is depicted according to an embodiment. The operating environment 100 may include one or more computing devices 110 and one or more electronic devices 115 configured to communicate with the one or more computing devices 110 via a communications network 105.

In an alternative embodiment, as depicted in FIG. 1B, the operating environment 100 may include one or more electronic devices 115 configured to communicate with one or more computing devices 110 via a communications network 105. The one or more computing devices 110 may further communicate with one or more sources 130. The one or more computing devices 110 may have a direct connection to the one or more sources 130, or may connect to the one or more sources via the communications network 105 or an additional communications network.

Referring to both FIGS. 1A and 1B, each of the one or more computing devices 110 may be any computing device having a processing device and a storage medium and may further optionally contain or be connected to one or more knowledge bases, databases, data volumes, datasets, metabases, logs, flat files, tables and/or the like. In embodiments where more than one computing device 110 exists, each computing device may operate independently of the other computing devices. In other embodiments, the computing devices may operate in an array-type configuration where the computing devices act as a single unit. In some embodiments, each computing device 110 may be owned and/or maintained by the same entity. In other embodiments, each computing device 110 may be owned and/or maintained by different entities. Each of the one or more computing devices 110 may generally contain or have access to information that is sought by scientists, researchers, analysts and/or the like.

The one or more electronic devices 115, such as, for example, a tablet 115a, a smartphone 115b, a feature phone 115c, a PDA 115d, a personal computer 115e and/or a laptop computer 115f, may generally serve as a primary interface with a user, and may further contain one or more applications that are configured to access the one or more computing devices 110, as described in greater detail herein. The one or more electronic devices 115 may generally contain programming instructions for interacting with the one or more computing devices 110, one or more databases 130 (FIG. 1B) and one or more users. The programming instructions may comprise programming for a querying program, as described in greater detail herein. The programming may be embodied within an application that may be received by the electronic device 115 from a provider, an app store, the one or more computing devices 110 and/or the like. In addition to having an ability to interact with one or more users, each electronic device 115 may further enable each user to interact with users of different electronic devices.

The one or more electronic devices 115 may further communicate with the one or more computing devices 110 via the communications network 105, as described in greater detail herein. The communications network 105 may serve as an information highway interconnecting the other illustrated components. The communications network 105 is not limited by this disclosure, and may include any communications network now known or later developed. The communications network 105 may utilize any suitable data communication, telecommunication, wired, wireless or other technology. The communications network 105 may be used to connect any number of devices, systems or components, including those not specifically enumerated herein, and may further use any number of communications links. For example, the communications network 105 may use one or more of a local area network (LAN), a wide area network (WAN), a wireless local area network (WLAN), a metropolitan area network (MAN), a personal area network (PAN), the internet, a cellular network, a paging network, a private branch exchange (PBX) and/or the like. The communications network 105 may further use social networking platforms for connecting users to each other. Data sent via the communications network 105 may be encrypted or may be unencrypted.

The one or more computing devices 110 may be coupled to the communications network 105 via a communications link, such as, for example, a wired link, a wireless link or any combination thereof. Furthermore, each electronic device 115 may be coupled to the communications network 105 via a communications link, such as, for example, a wired link, a wireless link or any combination thereof.

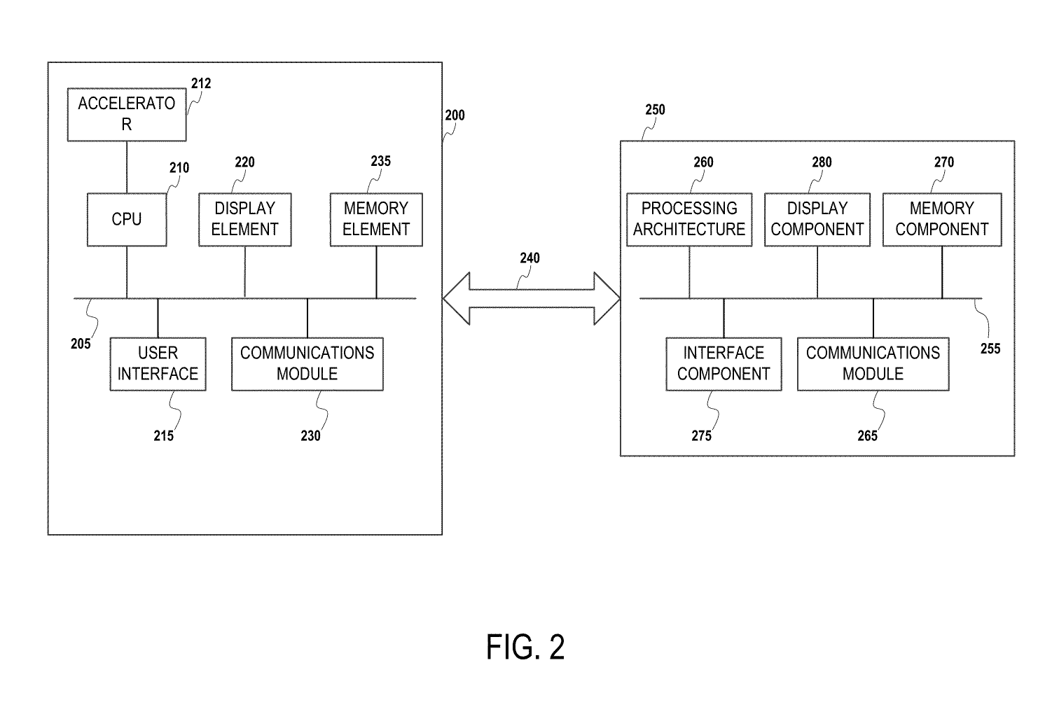

FIG. 2 depicts a schematic representation of communications between an electronic device 200 and one or more computing devices 250, arranged in accordance with at least some embodiments described herein. The electronic device 200 may communicate with the one or more computing devices 250 via a communications link 240, such as, for example, the communications network 105 depicted in FIGS. 1A and 1B.

The electronic device 200 may generally include one or more of a CPU 210, a user interface 215, a display element 220, a communications module 230 and a memory element 235. Furthermore, the CPU 210 may optionally be connected to one or more accelerators 212. The modules and/or elements outlined herein are merely examples, and other modules and/or elements may also be included within the electronic device 200 without departing from the scope of the present disclosure. Examples of other modules and/or elements may include, but are not limited to, global positioning satellite (GPS) components, near field communication (NFC) components, Bluetooth components, a barometer, a thermometer, a hygrometer, a cellular radio, an 802.11 wireless radio and/or a wired data communication interface. A bus 205 may serve as an information highway interconnecting the modules and/or elements of the electronic device 200.

The CPU 210 may generally be any processing device that executes one or more operations based on programming instructions stored in the memory element 235. The CPU 210 may further be aided by one or more accelerators 212, such as, for example, graphics processing units (GPUs), field programmable gate arrays (FPGAs), digital signal processors (DSPs) and/or the like. In an embodiment, the one or more operations may be completed by the CPU 210. In other embodiments, the one or more operations may be completed by the CPU 210 and/or the one or more accelerators 212. In other embodiments, the CPU 210 and/or the one or more accelerators 212 may direct other components to complete the one or more operations, as described in greater detail herein.

The CPU 210 may include any number of hardware, software and/or firmware components, as well as any number of logical or functional modules. In an embodiment, the CPU 210 may be a general purpose processing device, a digital signal processor, an application-specific integrated circuit, a field programmable gate array (FPGA), a programmable logic device, a logic gate, and/or combinations thereof. In other embodiments, the CPU 210 may be a processing device coupled with one or more accelerators 212, such as, for example, a general purpose processing device, a digital signal processor (DSP), an application-specific integrated circuit, a field programmable gate array (FPGA), a programmable logic device, a logic gate, and/or combinations thereof. In some embodiments, the CPU 210 and/or the one or more accelerators 212 may further be a microprocessor, a controller, a microcontroller, a state machine or any combination thereof.

The user interface 215 may include, for example, one or more user interface components that may generally be configured to elicit one or more commands to the electronic device 200 when actuated. Examples of user interface components may include keypads, switches, buttons, visual control components, audio control components, haptic control components and/or the like.

The user interface 215 may further include a touch sensitive screen, which may optionally be integrated with the display element 220. The touch sensitive screen may receive contact based inputs from a user, such as from a user's fingers or from a stylus. The touch sensitive screen may be adapted for gesture control, thus allowing for a user to tap, pinch, swipe or provide other similar gestures to elicit commands to the electronic device 200. The touch sensitive screen may further be capable of sending touch commands to the CPU 210. Examples of touch sensitive screens may include, but are not limited to, resistive touchscreens, capacitive touchscreens, infrared touchscreens and/or other technologies now known or later developed. The user interface 215 may also be configured to receive commands via body gestures, voice, audio signals, device movement and/or the like, which may be completed through the use of one or more of a microphone, a speaker, a camera, a barometer, a gyroscope and/or the like.

In an embodiment, the display element 220 may be an interactive element capable of interacting with a user, as described in greater detail herein. The display element 220 may generally be used to display images, text, video, two dimensional (2D) images and/or video, three dimensional (3D) images and/or video and the like to a user of the electronic device 200 according to commands received from the CPU 210. Examples of display elements may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

The communications module 230 may generally provide an interface between the electronic device 200 and the communications link 240. The communications module 230 may be configured to process data transmitted or received via a wired and/or a wireless interface. The wired interface may include, but is not limited to, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (I²C), Serial Peripheral Interface Bus (SPI), RS-485, any Small Computer System Interface (SCSI), Process Field Bus (Profibus), Universal Serial Bus (USB), FireWire (1394), Fibre Channel, Camera Link, Peripheral Component Interconnect Express (PCI Express), Thunderbolt and the like. The wireless interface may include, but is not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS) and the like.

The memory element 235 may generally be any type of fixed or removable storage device. Examples of memory elements 235 may include, but are not limited to, random access memory (RAM), read only memory (ROM), erasable programmable read only memory (EPROM), electrically erasable programmable read only memory (EEPROM), flash memory, magnetic computer storage devices, optical discs, hard disks, removable disks and the like.

The memory element 235 may generally provide storage for data and/or information, such as program data/information, data/information saved by one or more users, programming instructions and/or the like. The data and/or information contained on the memory element 235 may be used to direct the CPU 210 to carry out one or more commands.

The one or more computing devices 250 may communicate with the electronic device 200 via the communications link 240. The one or more computing devices 250 may have, either individually or collectively, a processing architecture 260, one or more communications modules 265, one or more memory components 270, one or more user interface components 275 and one or more display components 280. The list of components illustrated here is merely an example, and other components of the one or more computing devices 250 may be included without departing from the scope of this disclosure. For example, other components may include global positioning satellite (GPS) components, near field communications (NFC) components, wireless communications radios, barometers, thermometers, hygrometers, gyroscopes, Bluetooth modules and/or the like. A bus 255 may serve as the main information highway interconnecting the other illustrated components of the one or more computing devices 250.

The processing architecture 260 may generally support the operation of the one or more computing devices 250, including the data processing schemes described in greater detail herein. The processing architecture 260 may be embodied in any number of hardware, software and/or firmware components, and may include any number of logical or functional modules. The processing architecture 260 may be implemented or performed with a processing device, a content addressable memory, a digital signal processor, an application specific integrated circuit, a field programmable gate array, any programmable logic device, any discrete gate or transistor logic, any discrete hardware components and/or the like. The processing device may be, for example, a microprocessor, a controller, a microcontroller, a state machine, an analog machine, or the like. Additionally, or alternatively, the processing device may be implemented as a combination of devices, such as, for example, a digital signal processor and a microprocessor, a plurality of microprocessors, and/or the like.

The one or more communications modules 265 of the one or more computing devices 250 may generally function similar to that of the communications module 230 of the electronic device 200. Thus, the one or more communications modules 265 may generally provide an interface between the one or more computing devices 265 and the communications link 240. The one or more communications modules 265 may further provide an interface between the one or more computing devices 265 and one or more of a database, a knowledge base, a metabase, a data set, a data volume and/or the like. The one or more communications modules 265 may be configured to process data transmitted or received via a wired and/or a wireless interface. The wired interface may include, but is not limited to, Ethernet, Human Interface Link (HIL), Musical Instrument Digital Interface (MIDI), Multibus, RS-232 (serial port), DMX512-A, IEEE-488 General Purpose Interface Bus (GPIB), EIA/RS-422, IEEE-1284 (parallel port), UNI/O, ACCESS.bus, 1-Wire, Inter-Integrated Circuit (I²C), Serial Peripheral Interface Bus (SPI), RS-485, any Small Computer System Interface (SCSI), Process Field Bus (Profibus), Universal Serial Bus (USB), FireWire (1394), Fibre Channel, Camera Link, Peripheral Component Interconnect Express (PCI Express), Thunderbolt and the like. The wireless interface may include, but is not limited to, radio frequency (RF), infrared, near field communication (NFC), Bluetooth, any IEEE 802.15 protocol, any IEEE 802.11 protocol, any IEEE 802.16 protocol, Direct Sequence Spread Spectrum (DSSS), Frequency Hopping Spread Spectrum (FPSS), cellular communication protocols, paging network protocols, magnetic induction, satellite data communication protocols, Wireless Medical Telemetry Service (WTMS), Universal Mobile Telecommunications System (UMTS), Global System for Mobile Communications (GSM), General Packet Radio Service (GPRS) and the like.

The memory element 270 may generally be any type of fixed or removable storage device. Examples of memory elements 270 may include, but are not limited to, random access memory (RAM), read only memory (ROM), erasable programmable read only memory (EPROM), electric erasable programmable read only memory (EEPROM), flash memory, magnetic computer storage devices, optical discs, hard disks, removable disks and the like.

The memory element 270 may generally provide storage for data and/or information, such as program data/information, data/information saved by one or more users, programming instructions and/or the like.

The user interface 275 may be similar to the user interface 215 of the one or more electronic devices 200. The user interface 275 may include, for example, one or more user interface components that may generally be configured to elicit one or more commands to the one or more computing devices 250 when actuated. Examples of user interface components may include keypads, switches, buttons, visual control components, audio control components, haptic control components and/or the like.

The user interface 275 may further include a touch sensitive screen. In an embodiment, the touch sensitive screen may receive contact based inputs from a user, such as from a user's fingers, a stylus and/or the like. In another embodiment, the touch sensitive screen may receive inputs from a user without any actual contact; the proximity of a user's fingers, a stylus and/or the like may provide controls for the touch sensitive screen, particularly in instances where three dimensional (3D images) are presented to a user. The touch sensitive screen may be adapted for gesture control, thus allowing for a user to tap, pinch, swipe or provide other similar gestures to elicit commands to the one or more computing devices 250. The touch sensitive screen may further be capable of sending touch commands to the processing architecture 260. Examples of touch sensitive screens may include, but are not limited to, resistive touchscreens, capacitive touchscreens, infrared touchscreens and/or other technologies now known or later developed. The user interface 275 may also be configured to receive commands via body gestures, voice, audio signals, device movement and/or the like, which may be completed through the use of microphones, speakers, cameras, barometers, gyroscopes and/or the like.

The display element 280 may be similar to the display element 220 of the one or more electronic devices 200, and may generally be used to display images, text, video and the like to a user of the one or more computing devices 250. Examples of display elements may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, organic light-emitting diode (OLED) displays, holographic devices, laser devices and/or the like.

Using the system depicted in FIG. 2, an electronic device 200 may receive a query from a user. The electronic device 200 and/or the one or more computing devices 250 may perform one or more operations to intelligently query a plurality of sources, and based upon the results obtained from the one or more sources, may provide an intelligent response to the user, as described in greater detail herein.

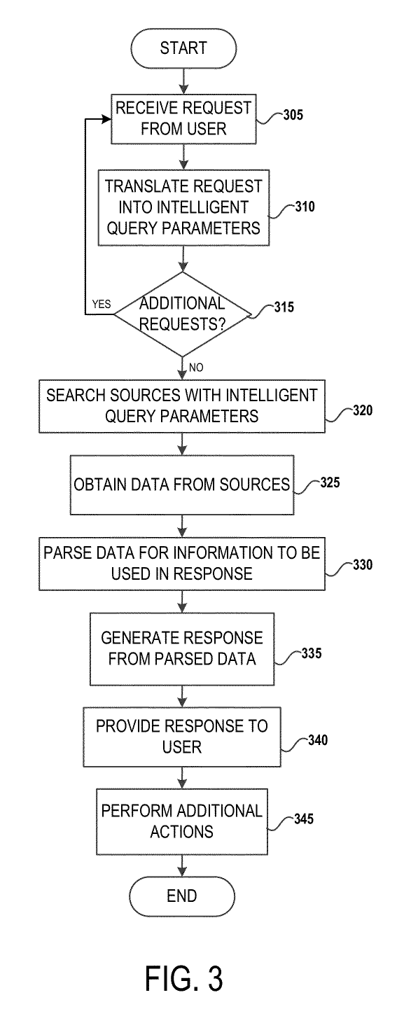

FIG. 3 depicts a plurality of operations that may be completed by an electronic device and/or a computing device. The electronic device and/or the computing device may receive 305 one or more requests from a user. The request may include, for example, a question, a request for data, a demand, a query and/or the like that may require a detailed answer. The request may further be, for example, in a natural language format. Topics for requests may include, for example, mapping, satellite imagery, climate conditions, plant and animal morbidity and mortality, insurance and actuarial data, emergency and disaster management information, forestry and fire service management information, mineral, natural resource and petroleum exploration and extraction, hydrology and water management, geology, food security, general academics and/or the like. The electronic device and/or the one or more computing devices may also optionally obtain additional information at the time the request is received. Examples of additional information may include, for example, positioning data, geospatial area data, GPS coordinates, altitude measurements, temperature measurements, humidity measurements and/or the like.

The electronic device and/or the one or more computing devices may translate 310 the request received from the user into one or more intelligent query parameters that generally contain the correct syntax for querying one or more sources. As each source may vary, the electronic device and/or the one or more computing devices may translate the request into varying intelligent query parameters that match the syntax required for each source. The translation 310 may be accomplished by any means of translation now known or later developed, and may further involve, for example, a semantic reasoner and/or the like that is capable of understanding natural language requests, selecting keywords, selecting phrases and/or selecting language structures from the requests and formulating proper intelligent query parameters that correspond to the request. The semantic reasoner may improve the translation abilities over time as additional requests are provided by one or more users. Furthermore, the semantic reasoner may use crowdsourcing, social networking and/or the like to improve its translation abilities.

The electronic device and/or the one or more computing devices may optionally decide 315 whether additional requests are needed, and if so, may receive 305 the additional requests. The determination 315 may be made based upon any number of factors, such as, for example, whether the user agrees that the intelligent query parameters correctly correspond to the request, whether a device administrator agrees that the intelligent query parameters correctly correspond to the request, whether the user has additional requests to enter, whether the electronic device and/or the one or more computing devices require requests from multiple users and/or the like.

If no additional requests are needed, the electronic device and/or the one or more computing devices may intelligently query 320 each source with the intelligent query parameters. Intelligent querying may be completed by connecting to the source via an interface, such as the interface described herein, to a computing device and/or the like upon which the source is located, and intelligently querying at least a portion of the data contained at the source for information that corresponds to the intelligent query parameters. In some instances, the source may have its own intelligent query engine. In these instances, the electronic device and/or the one or more computing devices may intelligently query 320 by providing the intelligent query parameters to the source's intelligent query engine and receiving the information returned from the intelligent query engine. Once the intelligent query parameters have been used, the electronic device and/or the one or more computing devices may obtain 325 data from the one or more sources. The data may be wholly related to the request, may be partially related to the request or may not be related to the request at all. All data obtained from each source, regardless of whether it is used to respond to the request (as described herein), may optionally be cataloged to allow for quicker intelligent queries in the future.

The electronic device and/or the one or more computing devices may parse 330 the data obtained from each source to determine which portions of the data (if any) should be used in formulating a response to the user's request. Parsing 330 may use the semantic reasoner discussed herein in order to determine which portions of the data should be used in formulating the response. The electronic device and/or the one or more computing devices may generate 335 a response from the parsed data. The response may generally be a natural language answer to the request presented by the user and may generally contain the parsed data that corresponds to the request. Furthermore, the response may be derived from data obtained from two or more sources. In addition, the response may be a service oriented modeling response. The response may optionally contain other elements, such as, for example, images, maps, video clips, audio clips, links to websites, links to sources, satellite imagery, aerial imagery, reports and/or the like.

The response and/or the other elements may be provided 340 to the user. This may be achieved by, for example, providing the response and/or the other elements on the display of the electronic device and/or the one or more computing devices. The electronic device and/or the one or more computing devices may perform additional actions 345, such as, for example, querying the user to confirm that the response was correct, querying the user to determine whether additional information is needed, performing additional query functions, obtaining additional date from the user, updating the semantic reasoner and/or the like.

### Examples

### Example

### Livestock Insurance

A user will ask an electronic device whether he/she should settle insurance payoffs to cattle ranchers. The user will also ask at what strike point should he/she use in a new insurance contract.

In response to receiving the above queries, the electronic device will determine that a livestock insurance from vegetation index (LMVI) will be used. The LMVI is generated from a regression-based predictive model that uses true historical mortality rates and historical satellite imagery along with current satellite imagery to predict livestock mortality. The estimated livestock mortality covers the period of time for the insurance contract (i.e., from the start of the growing season to the date the prediction is made). The mortality index is designed to be utilized as an indicator for an index-based insurance and is not an absolute measure of mortality. The model utilizes visible and near infrared satellite data and ground-based historical mortality rate.

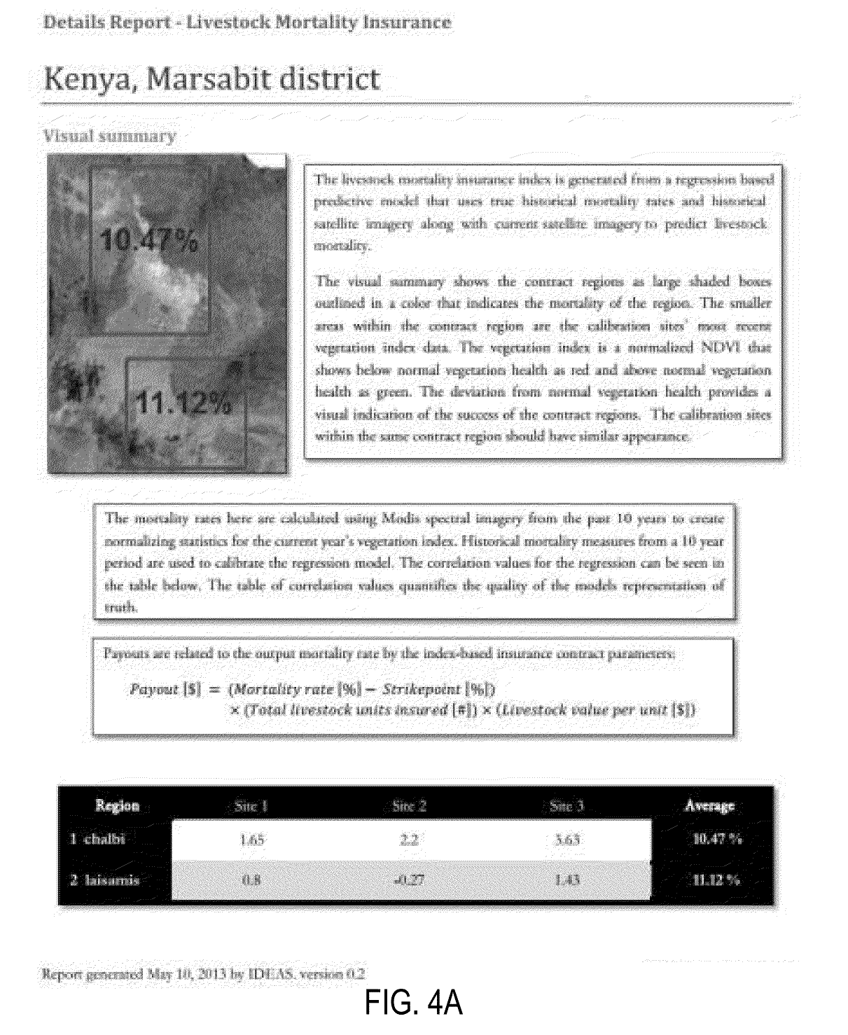

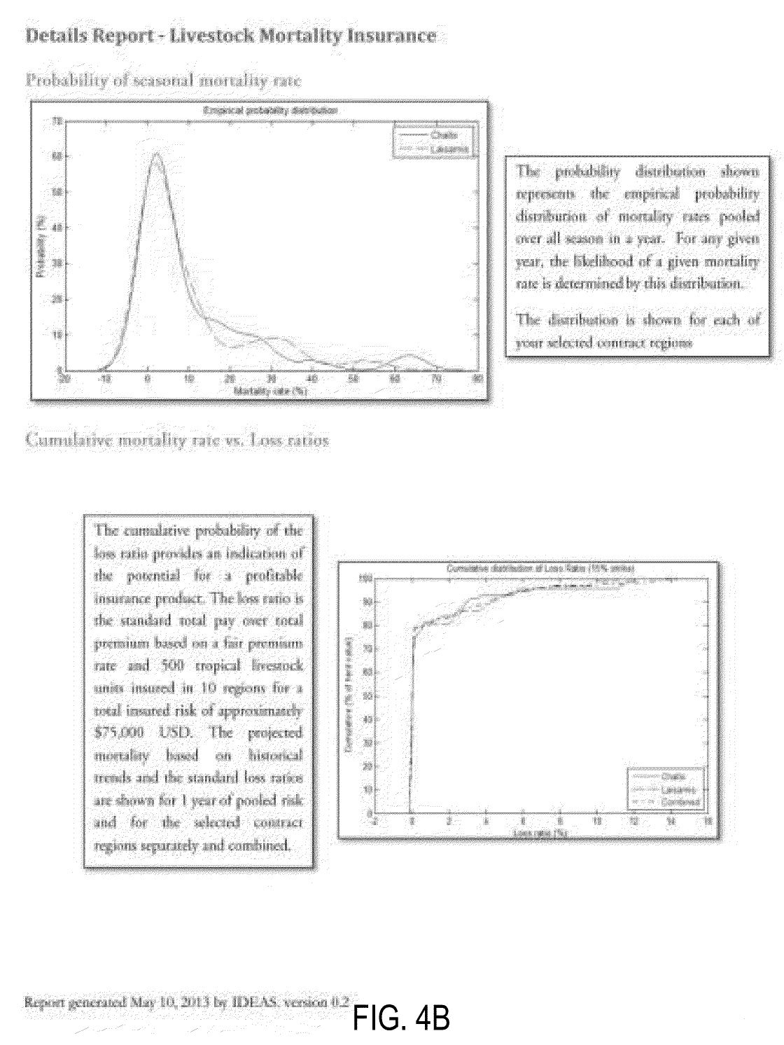

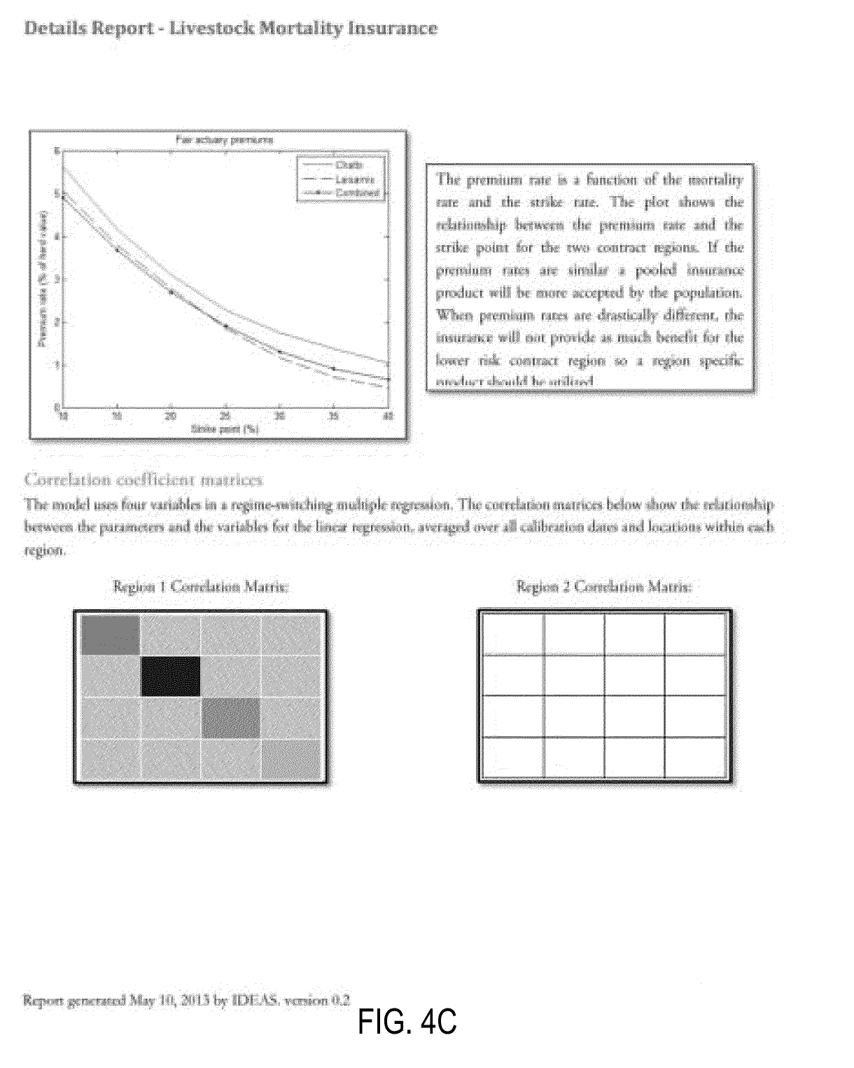

The electronic device will ask the user a plurality of follow up questions in order to identify the exact details of the report the user would like to see. Examples of follow up questions include questions regarding product details, questions regarding contract regions of interest, questions regarding the contract period of interest and questions regarding desired maps, reports, and/or the like. The electronic device will then provide the user with a report that includes maps, models, explanations, charts and/or the like, such as the report depicted in FIGS. 4A-4C.

### Example 2

### Wildfire Management

A user will tell the electronic device that he/she needs to visualize terrain influenced winds throughout a given area 4 hours from now to assess the risks of wildfire spreading to a nearby residential community.

The computing device will access a wind prediction module to determine a proper response. The wind prediction module can provide both terrain based wind predictions and value added burn mapping that show current and past fire lines for a given area of interest. The wind predictions are based on the WindNinja model developed for the U.S. Forest Service and designed to simulate micro-scale, terrain-influenced winds. The WindNinja model simulates the spatial variations of wind versus time. The primary purpose is for predicting winds for use in predicting wildfire movement. The model utilizes as data inputs: (1) National Oceanic and Atmospheric Administration (“NOAA”) Current Wind Data at the desired location and (2) United States Geological Survey (“USGS”) land elevation data at 30 meter resolution for the area selected by the user.

The electronic device will ask the user a plurality of follow up questions in order to identify the exact details of the report the user would like to see. Examples of follow up questions include questions regarding product details, questions regarding the area of interest, questions regarding wind model parameters for the WindNinja model and questions regarding desired maps, reports, and/or the like. The electronic device will then provide the user with a report, which will include maps, animated models and/or the like to answer the user's question.

Variations of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of providing an intelligent response, comprising:
receiving, by a processing device, a request from a user;
translating, by the processing device, the request into one or more intelligent query parameters;
querying, by the processing device, a plurality of sources in accordance with the one or more intelligent query parameters;
obtaining, by the processing device, data from the plurality of sources;
generating, by the processing device, a response to the request from the data, wherein the response comprises a report containing at least a portion of the data from at least two sources; and
providing, by the processing device, the response to the user.

2. The method of claim 1, wherein the one or more intelligent query parameters comprises a geospatial area.

3. The method of claim 2, wherein generating the response to the request from the data further comprises generating the response to the request based upon the geo spatial area.

4. The method of claim 1, wherein the plurality of sources includes at least one of a geospatial source, a climate source, a plant morbidity source, a plant mortality source, an animal morbidity source, an animal mortality source, an actuarial source, an emergency management source, a disaster management source, a forestry service management source, a fire service management source, a mineral exploration source, a mineral extraction source, a natural resource exploration source, a natural resource extraction source, a petroleum exploration source, a petroleum extraction source, a hydrology source, a water management source, a geologic source, a United States government agency source, a satellite source, an aerial image source, an imagery source, a health source and an actuary source.

5. The method of claim 1, wherein the plurality of sources includes a metabase.

6. The method of claim 1, wherein the plurality of sources comprises content generated by the user.

7. The method of claim 1, wherein the plurality of sources comprises content generated by a collective of users.

8. The method of claim 1, wherein the response comprises a service oriented modeling response.

9. The method of claim 1, wherein the response comprises a report containing at least one image.

10. A system for providing an intelligent response, the system comprising:
a processing device; and
a non-transitory, processor-readable storage medium in communication with the processing device, wherein the non-transitory, processor-readable storage medium contains one or more programming instructions that, when executed, cause the processing device to:
receive a request from a user;
translate the request into one or more intelligent query parameters;
query a plurality of sources in accordance with the one or more intelligent query parameters;
obtain data from the plurality of sources;
generate a response to the request from the data, wherein the response comprises a report containing at least a portion of the data from at least two sources; and
provide the response to the user.

11. The system of claim 10, wherein the one or more intelligent query parameters comprises
a geospatial area.

12. The system of claim 11, wherein the one or more programming instructions that, when executed, cause the processing device to generate the response to the request from the data further comprises one or more programming instructions that, when executed, cause the processing device to generate the response to the request based upon the geospatial area.

13. The system of claim 10, wherein the plurality of sources includes at least one of a geospatial source, a climate source, a plant morbidity source, a plant mortality source, an animal morbidity source, an animal mortality source, an actuarial source, an emergency management source, a disaster management source, a forestry service management source, a fire service management source, a mineral exploration source, a mineral extraction source, a natural resource exploration source, a natural resource extraction source, a petroleum exploration source, a petroleum extraction source, a hydrology source, a water management source, a geologic source, a United States government agency source, a satellite source, an aerial image source, an imagery source, a health source and an actuary source.

14. The system of claim 10, wherein the plurality of sources includes a metabase.

15. The system of claim 10, wherein the plurality of sources comprises content generated by the user.

16. The system of claim 10, wherein the plurality of sources comprises content generated by a collective of users.

17. The system of claim 10, wherein the response comprises a service oriented modeling response.

18. The system of claim 10, wherein the response comprises a report containing at least one image.
